(19) United States
(12) Patent Application Publication
(10) Pub. No.: US 2021/0370251 A1
(43) Pub. Date: Dec. 2, 2021

(54) Machine and Method to Automatically Dispense Fluid Products, In Particular Liquid Dyes

(71) Applicant: Corob S.P.A., San Felice sul Panaro (IT)

(72) Inventors: Andrea Alvisi, Spliamberto (IT); Roberto Avanzi, Finale Emilia (IT)

(73) Assignee: Corob S.P.A., San Felice sul Panaro (IT)

(21) Appl. No.: 17/401,132

(22) Filed: Aug. 12, 2021

Related U.S. Application Data
(63) Continuation of application No. PCT/IT2020/050024, filed on Feb. 11, 2020.

(30) Foreign Application Priority Data
Feb. 12, 2019 (IT) 102019000001967
Feb. 12, 2019 (IT) 102019000001969
Mar. 12, 2019 (IT) 102019000001971

(51) Int. Cl. B01F 13/10; B05B 15/25; B05B 15/70; B01F 15/02

(52) U.S. Cl. CPC B01F 13/1058; B05B 15/25; B01F 2003/0028; B01F 15/0247; B05B 15/70

(57) ABSTRACT

A machine to automatically dispense at least one fluid product, in particular a liquid dye, comprising support members configured to support one or more dispensing units each having a tank, in which said fluid product to be dispensed is contained, a dispensing nozzle and a pumping member, configured to selectively convey a desired quantity of the fluid product from the tank to the dispensing nozzle and from the latter to an external container. Rapid attachment means, drivable by an actuation element, which can also be possibly driven manually, are present to allow the easy and simple positioning of each dispensing unit on the support means and the equally easy and simple removal of each dispensing unit from the support members.

### CROSS-REFERENCE TO RELATED APPLICATIONS

This application is a continuation application of and claims priority under 35 U.S.C. § 120 and priority under 35 U.S.C. §§ 363, 365 to International Patent Application No. PCT/IT2020/050024, filed Feb. 11, 2020, which was published in the English language, and which claims priority under 35 U.S.C. § 119 to Italian Patent Applications Nos. 102019000001967, 102019000001969 and 102019000001971, each filed on Feb. 12, 2019. The entire disclosures of all of the foregoing applications are incorporated herein by reference.

### BACKGROUND OF THE INVENTION

### Field of the Invention

The present invention concerns a machine and the corresponding method to automatically dispense fluid products, in particular liquid dyes, such as for example liquid dyes, paints, enamels, inks, or other fluid coloring substances, in a container in which a base product may already be present. However the field of application of the present invention also includes other sectors of the art, such as the dispensing, or distribution, of drinks, detergent liquids, or other fluid, liquid, or gaseous substances.

### Description of Related Art

Dispensing machines, or dispensers, are known, for dispensing fluid products, in particular, but not only, liquid dyes, able to introduce a metered quantity of fluid substances, for example coloring pigments, into a container in which a base product may also be possibly present, to obtain the desired coloring product.

From the international patent application WO-A-2012/104723 a machine for dispensing fluid products is known which comprises a base structure, a base support, circular in shape, mounted on the base structure and a platform rotating selectively with respect to the base support, around a central and vertical axis of rotation. Sixteen units for dispensing the fluid products are mounted on the rotatable platform, disposed in a circle around the axis of rotation.

Each dispensing unit comprises both a tank, which contains a corresponding product to be dispensed, and a dispensing nozzle. The selective rotation of the rotatable platform allows each of the dispensing units to be positioned in a defined angular position, in which, on the base structure, a single actuation unit is disposed, so that the fluid product, contained in the corresponding tank can be dispensed to a container disposed on the same base structure, in correspondence with the defined angular position as above, for subsequent use, transport and storage. WO-A-2012/104723 also provides rapid connection means in order to obtain both the removable connection of the base support with respect to the base structure, and also the removable connection of the base support with respect to the sliding means configured to allow the rotation of the rotatable platform about the axis of rotation as above, in order to obtain a selective, but stable, coupling thereof and at the same time to prevent their reciprocal vertical movement parallel to the axis of rotation as above.

Although functional, the known machine described in WO-A-2012/104723 has the disadvantage however that it is rather complex and although it does allow the removal in a single block of all the dispensing units with respect to the base below, it does this with an operation that is not easy to carry out, considering the weight of the whole assembly, and does not allow the individual removal and replacement of each of the different dispensing units, including the tank and dispensing nozzle.

Machines for dispensing fluid products are also known in the art in which the individual containers of the various fluid products can be removed from their respective seatings, for example, in some cases, to allow them to be filled with another fluid product, once the product contained inside it runs out. Examples of this type of machines are described in the patent documents EP 3.318.318, U.S. Pat. No. 5,232,664, US 2007/272710, US 2016/144326 and U.S. Pat. No. 6,244,474.

One disadvantage of these machines is that the extraction of the containers requires an axial movement thereof, substantially parallel to the main axis of rotation of these machines. This axial movement can be inconvenient for operators, who have to lift the containers, which normally weigh a few kilograms, even to a vertical height that is difficult to reach, and can also determine significant sizes of the maneuvering space required in the machine or in its immediate vicinity for the extraction of the containers.

### BRIEF SUMMARY OF THE INVENTION

One purpose of the present invention is to provide a machine and perfect the corresponding method for the automatic dispensing of fluid products, in particular liquid dyes, but not only, for example to a container, which are reliable, functional and inexpensive, and which at the same time allow the individual removal and replacement of each dispensing unit with which the machine is equipped, for example from one to dozens of them, with a simple operation, which can also be carried out by an unskilled user and without the use of any tool and/or device.

Another purpose of the present invention is to provide a machine and perfect the corresponding method for the automatic dispensing of fluid products, in particular liquid dyes, but not only, for example to a container, in which, given a large number of single dispensing units present in the machine, for example greater than fifteen, each provided with a tank for containing a corresponding fluid product, a dispensing nozzle and associated pumping means, it is possible to have very simple actuation means that collaborate selectively with each of the dispensing units, to automatically dispense the selected fluid product.

Another purpose of the present invention is to provide a machine and perfect the corresponding method for the automatic dispensing of fluid products, in particular liquid dyes, but not only, for example to a container, in which it is also possible to mix the fluid products inside each tank, in a simple and automatic manner, without needing to motorize each dispensing unit.

A further purpose of the present invention is to provide a machine and perfect the corresponding method for the automatic dispensing of fluid products, in particular liquid dyes, but not only, for example to a container, in which it is also possible to recirculate the fluid products inside the corresponding tanks, in a simple and automatic manner, substantially using the same members and components, suitably commanded, responsible for carrying out the metered dispensing of the same fluid products.

The Applicant has studied, tested and embodied the present invention to overcome the shortcomings of the state of the art and to obtain these and other purposes and advantages.

The present invention is set forth and characterized in the independent claims.

The related dependent claims describe other characteristics of the invention, or variants to the main inventive idea.

In accordance with the above purposes, a machine according to the present invention, for the automatic dispensing of one or more fluid products, in particular liquid dyes, but not only, comprises support means configured to support at least one dispensing unit including a tank, in which the fluid product to be dispensed is contained, a dispensing nozzle and pumping means configured to selectively convey a desired quantity of the fluid product as above from the tank as above to the dispensing nozzle as above and from the latter to an external containing mean.

In accordance with one characteristic of the present invention, the machine, also, comprises rapid attachment means configured to allow the easy and simple positioning of the at least one dispensing unit as above on the support means and the equally easy and simple removal of the at least one dispensing unit as above from the support means.

In accordance with another characteristic of the present invention, the rapid attachment means comprise both fixed attachment means mounted on the support means as above, and also an attachment member mounted on the dispensing unit; in addition, the attachment member as above is mobile between a clamping position and a release position and comprises an actuation element which can also be driven manually from outside the dispensing unit as above.

In accordance with another characteristic of the present invention, the fixed attachment means as above comprise an attachment element integral with the support means as above and having an end protruding towards the outside of the machine and provided with a through hole defining a terminal tooth; moreover, the actuation element as above is configured to cooperate selectively with the end of the attachment element as above.

In accordance with another characteristic of the present invention, the actuation element as above has a substantially cylindrical shape, is disposed axially mobile inside a corresponding cylindrical cavity of a structural part of the dispensing unit as above and has both an internal part, which has an external diameter slightly smaller than the diameter of the through hole as above of the end as above of the fixed attachment element as above, and also an external part, which at least partly protrudes from the structural part as above of the dispensing unit as above, to be actuated manually.

In accordance with another characteristic of the present invention, the internal part as above is provided with a transverse cavity with a semi-cylindrical shape, which has the radius of curvature slightly larger than that of the end as above of the fixed attachment element as above; a conditioning mean is, also, provided, for example configured as a helical spring, to constantly condition the actuation element as above towards the clamping position as above.

In accordance with another characteristic of the present invention, the weight of the dispensing unit as above as a whole and the sizes of the structural part as above are such as to allow an adult person to grasp and manipulate the dispensing unit as above with one hand only and that the actuation element as above is disposed in a position such that it can possibly be operated with a single finger of the same hand.

In accordance with another characteristic of the present invention, the support means as above comprise a rigid structure provided with a substantially horizontal through cavity; moreover, the pumping means as above are contained in a lower structure of the dispensing unit as above, substantially having a cross section substantially mating with that of the through cavity as above, so that the latter can accurately house the lower structure as above of the dispensing unit as above when the latter is mounted on the support means as above.

In accordance with another characteristic of the present invention, the presence of a plurality of dispensing units is provided, each mounted in an individually removable manner on a platform selectively rotating with respect to a fixed structure, around its own central axis; moreover, the support means as above are mounted on the rotatable platform as above so as to rotate together with it. In this configuration, the machine according to the present invention, also, comprises a single actuation unit disposed radially with respect to the central axis as above in a dispensing zone of the fixed structure as above and configured to selectively and autonomously actuate both the dispensing nozzle as above, and also the pumping means as above of the dispensing unit which is temporarily located in the dispensing zone as above, by rotating the platform as above.

In accordance with another characteristic of the present invention, the platform as above has a substantially annular shape and defines a central through cavity; furthermore, the plurality of dispensing units as above is disposed in a circle on the platform as above; in addition, the actuation unit as above comprises both an internal part, mounted on the fixed structure as above, in the central through cavity as above, and configured to selectively activate the pumping means as above, and an external part mounted on the fixed structure as above but outside said platform and configured to selectively activate the dispensing nozzle as above.

According to another aspect of the present invention, the machine, also, comprises a single mixing unit, disposed radially with respect to the central axis as above in a mixing zone of the fixed structure as above, angularly offset with respect to a zone for dispensing the fluid product and configured to selectively and autonomously mix the fluid product contained in the tank as above of the dispensing unit which is temporarily located in the mixing zone as above, by rotating the platform as above.

According to a further characteristic of the present invention, a method to automatically dispense at least one fluid product, in particular a liquid dye, by means of a machine having support means configured to support at least one dispensing unit including a tank, in which the fluid product to be dispensed is contained, a dispensing nozzle and pumping means configured to selectively convey a desired quantity of the fluid product as above from the tank as above to the dispensing nozzle as above and from the latter to an external containing mean, comprises at least one installation step and possible subsequent removal of the at least one dispensing unit as above by means of rapid attachment means configured to allow the easy and simple positioning of the at least one dispensing unit as above on the support means as above and the equally easy and simple removal of the at least one dispensing unit as above from the support means as above.

In accordance with a further characteristic of the present invention, the installation step as above comprises a first sub-step in which a structural part of the dispensing unit is grasped, possibly even with only one hand of an adult person, so that the dispensing unit as above can be positioned in correspondence with the support means as above, and a second sub-step, which can also be simultaneous with or prior to the first sub-step as above, in which an actuation element, which is part of the rapid attachment means as above, is driven, possibly even with a single finger of the same hand, to cooperate with fixed attachment means, which are part of the rapid attachment means and which are mounted on the support means as above.

### BRIEF DESCRIPTION OF THE SEVERAL VIEWS OF THE DRAWINGS

These and other characteristics of the present invention will become apparent from the following description of a preferential embodiment, given as a non-restrictive example, with reference to the attached drawings wherein:

FIG. 1 is a front right perspective view that schematically shows a machine for automatically dispensing fluid products, in particular liquid dyes, according to the present invention;

FIG. 2 is a first top view of the machine in FIG. 1, in which some components have been removed to better show some internal parts thereof;

FIG. 3 is a second top view of the machine in FIG. 1, in which other components have been removed to better show some internal parts thereof;

FIG. 4 is a front perspective view of an enlarged detail of the machine in FIG. 1;

FIG. 5 is a front view of one of the dispensing units of the machine in FIG. 1;

FIG. 6 is a perspective view of one of the dispensing units of the machine in FIG. 1, in which the cylindrical wall of the relative tank has been removed, to show the mixing member disposed inside the latter;

FIG. 7 is a lateral view of one of the dispensing units of the machine in FIG. 1, in a position detached from the corresponding support member;

FIG. 8 is a perspective view of the dispensing unit in FIG. 7, in the same position detached from the corresponding support member;

FIG. 9 is a left lateral view of the dispensing unit in FIGS. 7 and 8, in a position where it is attached to the corresponding support member;

FIG. 10 is a right lateral view of the dispensing unit in FIGS. 7 and 8, in a position where it is attached to the corresponding support member;

FIG. 11 is a front view of the support member in FIGS. 7 to 10, highlighting the clamping position of a corresponding clamping member, which is part of the corresponding dispensing unit;

FIG. 12 is a front view of the support member in FIG. 11, highlighting the release position of the corresponding clamping member;

FIG. 13 is a lateral view, slightly in perspective, of one of the dispensing units of the machine in FIG. 1, positioned in correspondence with its only actuation unit;

FIG. 14 is a perspective view, taken from the internal part of the machine in FIG. 1, of the dispensing unit in FIG. 13, positioned in correspondence with the only actuation unit;

FIG. 15 is a lateral view showing only the single actuation unit, without any dispensing unit;

FIG. 16 is a perspective view of the actuation unit in FIG. 15;

FIG. 17 is a perspective view that shows only a front part of the actuation unit in FIG. 15, on an enlarged scale;

FIG. 18 is a rear view, partly sectioned, of the front part of the actuation unit in FIG. 17;

FIG. 19 is a longitudinal section of a nozzle of a dispensing unit of the machine in FIG. 1, on an enlarged scale and in the closed position, or recirculation position;

FIG. 20 is a longitudinal section of the nozzle in FIG. 19 in the open position, or dispensing position;

FIG. 21 is a top view of the dispensing unit in FIGS. 7 and 8, from which the tank has been removed;

FIG. 22 is a perspective view of a part of the dispensing unit in FIG. 21, which contains a volumetric pump;

FIG. 23 is a top view of the part of the dispensing unit in FIG. 22;

FIG. 24 is a perspective view of the only mixing unit of the machine in FIG. 1, on an enlarged scale; and

FIG. 25 is a top view of the only mixing unit in FIG. 24.

### DETAILED DESCRIPTION OF THE INVENTION

We must clarify that in the present description and in the claims the terms vertical, horizontal, lower, upper, right, left, high and low, with their declinations, have the sole function of better illustrating the present invention with reference to the drawings and must not be in any way used to limit the scope of the invention itself, or the field of protection defined by the attached claims. For example, by the term horizontal we mean a plane that can be either parallel to the line of the horizon, or inclined, even by several degrees, for example up to 30°, with respect to the latter.

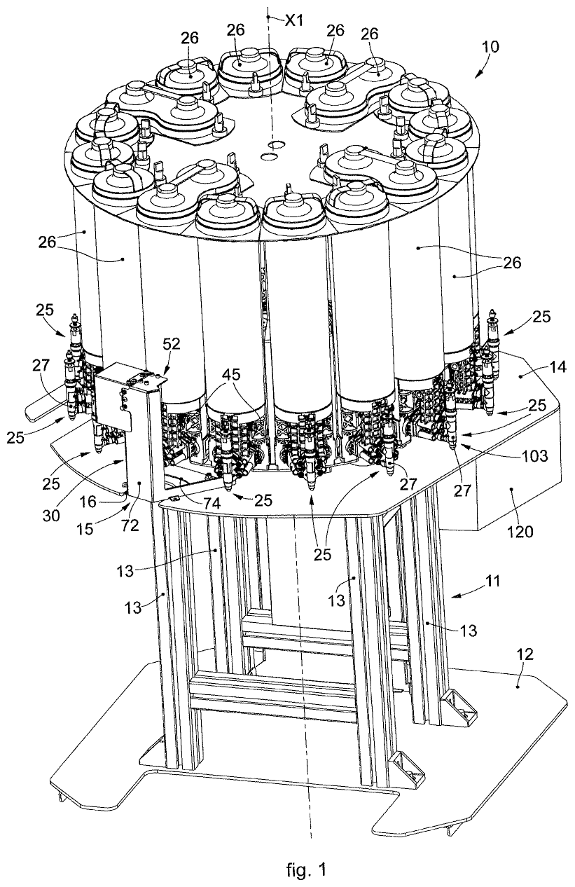

With reference to FIG. 1, a machine 10 according to the present invention, for the automatic dispensing of fluid products, in particular, but not only, liquid dyes, comprises a base structure 11, having a central vertical axis X1 and substantially consisting of a lower horizontal plate 12, on which four vertical uprights 13 are attached, on which an upper horizontal plate 14 is attached. For example, the fluid coloring products can be liquid dyes, paints, enamels, inks, or other fluid coloring substances, suitable to be contained in a suitable container of any type and not shown in the drawings, in which a base product may, optionally, already be present. In turn, for example, the base product may be a neutral, transparent, or white colored paint, to which a dye is then added, consisting substantially of coloring pigments.

in a dispensing zone 15, disposed in the front part of the machine 10, the upper horizontal plate 14 is provided with a central through cavity 16, below which, in any suitable manner, the container as above is suitable to be positioned.

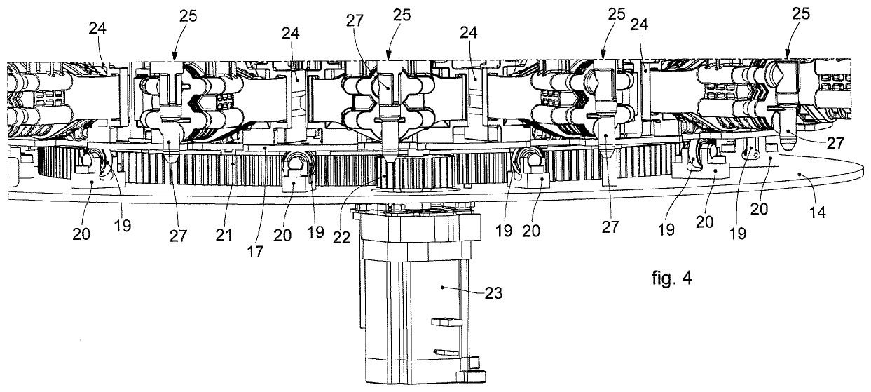

On the upper horizontal plate 14, centered with respect to the vertical central axis X1, a platform 17 (FIGS. 3 and 4) is rotatably mounted having a substantially annular shape, which defines a central through cavity 18.

More specifically, the platform 17 is rotatably supported by a series of ten rollers 19, each of which is rotatably mounted on a corresponding support 20 attached on the upper surface of the upper horizontal plate 14. The rollers 19 (FIG. 3) are positioned angularly equidistant from each other and coaxial to the central vertical axis X1.

The lower part of the platform 17 is provided with a circular toothed rack 21, concentric with the central vertical axis X1. A first toothed pinion 22, connected to the shaft of a first electric motor 23 (FIGS. 3 and 4), is constantly engaged with the circular toothed rack 21, in order to selectively rotate the platform 17, clockwise, or counterclockwise, as will be described in detail below.

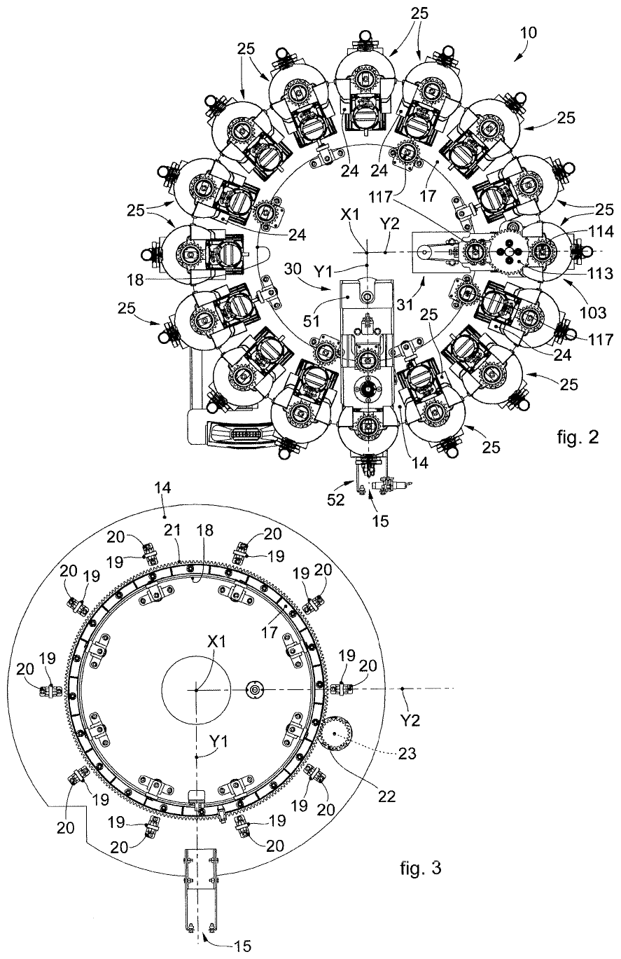

On the upper part of the platform 17 a plurality of support members 24 are attached (FIGS. 2, 4, 6, 7, 8, 11 and 12), which in the example provided here are sixteen, which are disposed concentric to the vertical central axis X1 and angularly equidistant from each other.

Each support member 24 is configured to support, in a removable manner, a corresponding dispensing unit 25 (FIGS. 1, 2 and from 5 to 8), which comprises a tank 26 (FIGS. 1 and from 5 to 8), configured to contain a fluid product, for example a liquid dye, a dispensing nozzle 27, a volumetric pump 28, and an attachment member 29, which will be described in detail below. In the example provided here the volumetric pump 28 is the bellows type, but it could be replaced by a piston pump, or a rotary pump.

Each tank 26, for example, is of a known type and can have a substantially cylindrical shape, having a vertical axis X2, or a double cylinder connected with a central joining part, as shown in FIG. 1, where there are four connected double-cylinder tanks 26 disposed at 90° with respect to each other.

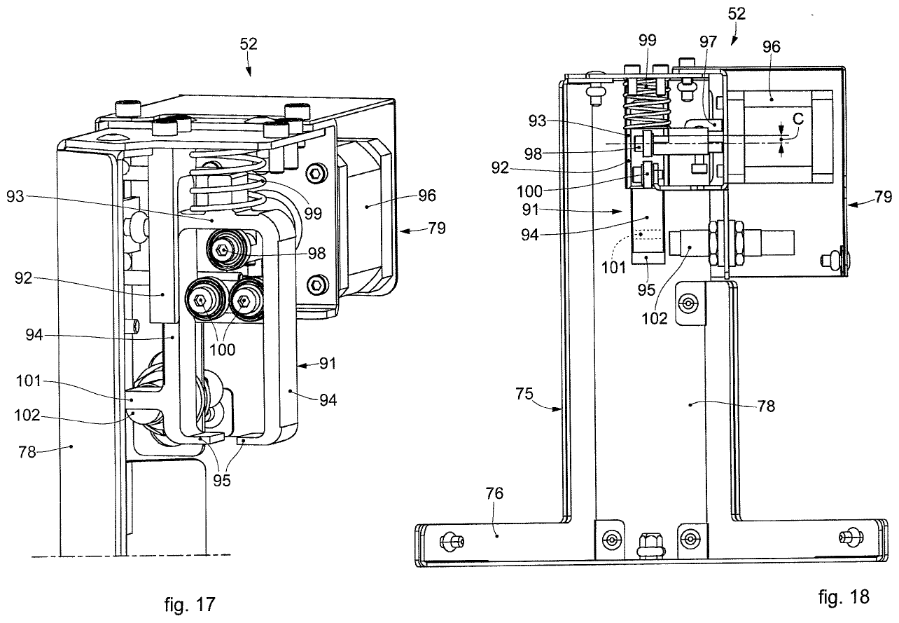

A single actuation unit 30 (FIGS. 1, 2 and 13 to 18), which will be described in detail below, is mounted on the upper horizontal plate 14, in a first fixed position, or dispensing position, in correspondence with the dispensing zone 15 and so as not to interfere with the rotation of the platform 17. In particular, the actuation unit 30 is disposed along a first radial axis Y1 (FIG. 2) horizontal and passing through the central vertical axis X1.

Furthermore, the machine 10 also comprises a single mixing unit 31 (FIGS. 2, 24 and 25), mounted on the upper horizontal plate 14 and disposed in the central through cavity 18 (FIG. 2) in a second fixed position, so as not to interfere with the rotation of the platform 17. In particular, the mixing unit 31, which will also be described in detail below, is disposed along a second horizontal radial axis Y2, passing through the central vertical axis X1 and angularly offset, for example by 90°, with respect to the first radial axis Y1.

### Rapid Attachment System

One of the inventive aspects of the present invention is the rapid attachment system, by means of which each dispensing unit 25 can be easily installed on and removed from one of the support members 24.

The rapid attachment means comprise fixed attachment means 37, mounted on the support members 24, and an attachment member 29, mounted on the dispensing unit 25, and mobile between a clamping position in which the dispensing unit 25 is clamped in position in the respective support members 24, and a release position in which the dispensing unit 25 is free to be removed from the respective support members 24.

It should be noted that the relative disposition of the dispensing units 25 and the support members 24 is such that the movement to install and remove each dispensing unit 25 with respect to its respective support member 24 takes place exclusively in a radial directrix, without any component of axial movement, that is parallel to the vertical central axis X1. The term “radial directrix” means that this movement extends along a radius of the circumference defined by the annular platform 17 and having the central vertical axis X1 as its center.

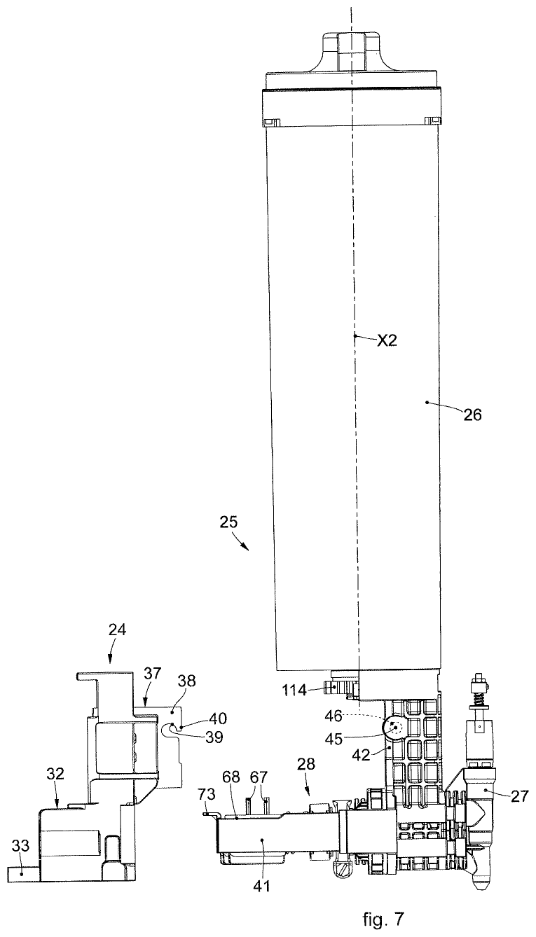

According to embodiments described here, each support element 24 (FIGS. 7, 8, 11 and 12) comprises a rigid structure 32, made for example by molding, having a base plate 33 attached on the platform 17, two lateral uprights 34 and one horizontal crosspiece 35, which together define a, substantially horizontal, through cavity 36. On the crosspiece 35 there is a fixed attachment element 37, defining the fixed attachment means as above, perpendicular to the development of the latter and having a cylindrical end 38 protruding horizontally towards the outside of the machine 10. The end 38 is provided with a substantially cylindrical through hole 39, parallel to the crosspiece 35, which defines a terminal tooth 40.

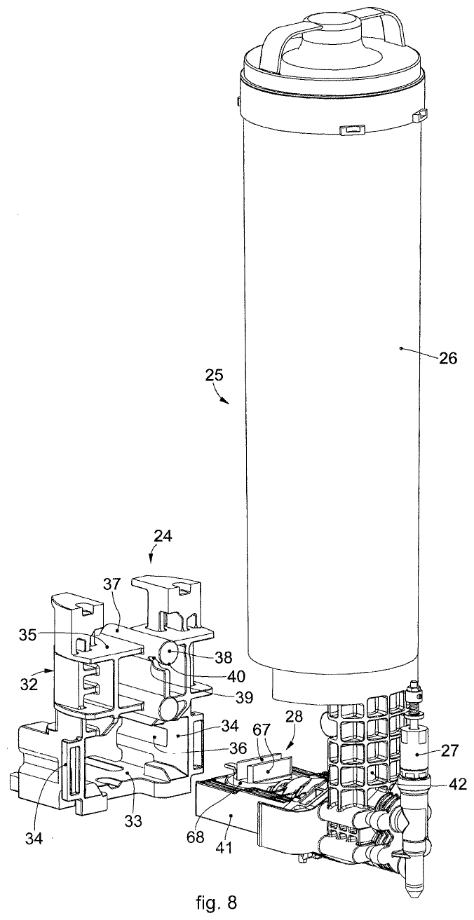

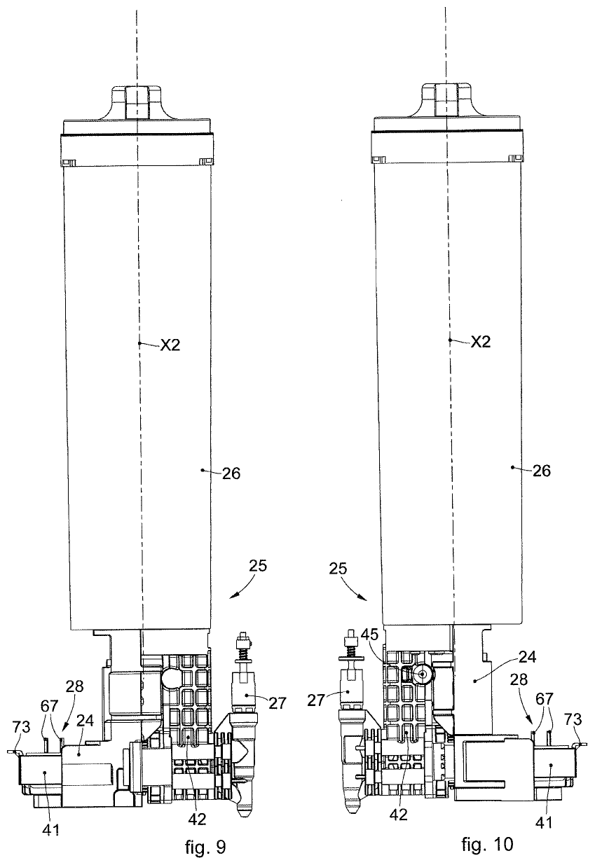

Each dispensing unit 25, below the tank 26, instead comprises a box-like lower structure 41 (FIGS. 7 and 8), substantially having the shape of a parallelepiped with a horizontal development and in which the corresponding volumetric pump 28 is inserted. The lower structure 41 is configured and sized to fit precisely into the through cavity 36 of the support member 24.

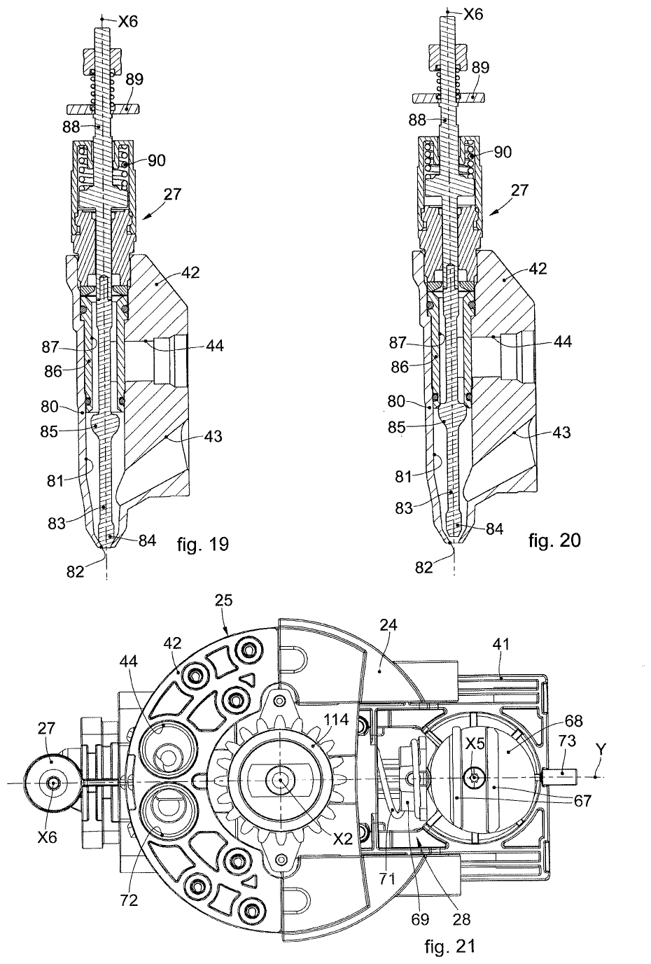

Furthermore, again below the tank 26, each dispensing unit 25 also comprises an intermediate structure 42 with a vertical development, in which the dispensing pipes 43 and the recirculation pipes 44 are made (partly visible in FIGS. 19 and 20), which, in a known manner, put the tank 26 in communication with the volumetric pump 28 and the dispensing nozzle 27, as will be described in detail below.

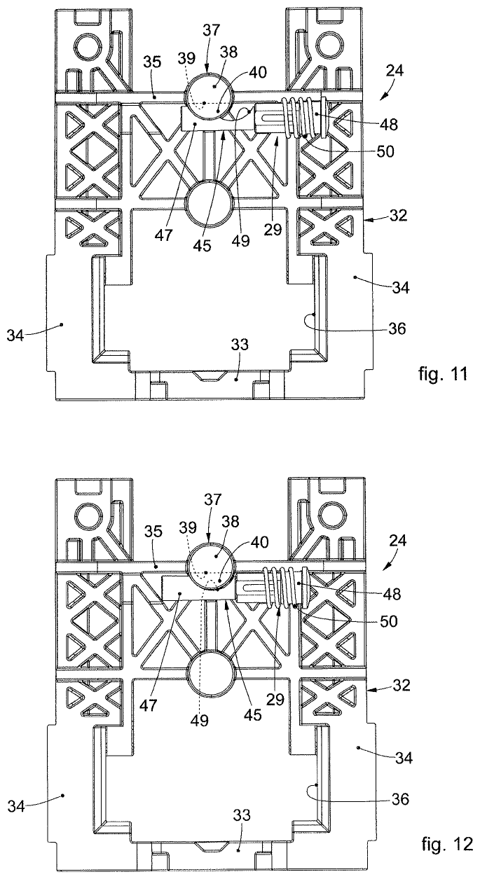

In the same intermediate structure 42 there is also the attachment member 29 (FIGS. 11 and 12), which comprises an actuation element 45, manually commandable and configured to move the attachment member 29 from the clamping position to the release position, for example to cooperate selectively with the end 38 of the fixed attachment element 37, that is with the terminal tooth 40, as will be explained below.

According to embodiments described here, the actuation element 45 (FIGS. 11 and 12) preferably has a substantially cylindrical shape, is disposed axially mobile inside a corresponding horizontal cylindrical cavity 46 (FIG. 7) made in the intermediate structure 42 in order to alternatively move the attachment member 29 to the clamping position or to the release position. The actuation element 45 has both an internal part 47, which has an external diameter slightly smaller than the diameter of the through hole 39 of the end 38 of the fixed attachment element 37, and also an external part 48, with a larger diameter, which at least partly protrudes from the intermediate structure 42, in order to be actuated manually. The actuation element 45, in particular its internal part 47, is provided with a recess 49 of a semi-cylindrical shape, which has the radius of curvature slightly greater than that of the end 38 of the fixed attachment element 37. A first helical spring 50, defining an elastic conditioning mean, is disposed around at least one portion of the actuation element 45, in this case in its external part 48, in order to constantly thrust the actuation element 45 towards the outside, in an inactive, or clamping position, schematically shown in FIG. 11.

It should be noted that the recess 49 has a shape mating with at least part of the profile of the terminal tooth 40, being configured to align with the latter when the attachment member 29 is in the release position to allow the positioning or removal of the dispensing unit 25 from the support means 24, and alternatively to misalign from the terminal tooth 40 when the attachment member 29 is in the clamping position.

By applying a force, even with a single finger, on the external part 48, the actuation element 45 (towards the left in FIG. 12) can be axially thrust inwards against the action of the first helical spring 50, to take it into an operating or release position, in which the transverse cavity 49 is coaxial with the end 38 of the fixed attachment element 37, that is coaxial with the terminal tooth 40.

The rapid attachment of each dispensing unit 25 to the support member 24 takes place in a very simple manner that is easy to be carried out even by a non-expert person, which might be the user of the machine 10.

In fact, with the machine 10 stopped, keeping the actuation element 45 pressed inwards in its operating position (FIG. 12), the entire dispensing unit 25 can be precisely coupled with a support member 24, by precisely inserting the lower structure 41 of the dispensing unit 25 into the through cavity 36 of the support member 24, until the intermediate structure 42 abuts against the rigid structure 32 of the latter. This action will also cause the simultaneous insertion of the end 38 of the fixed attachment element 37 into the transverse cavity 49 of the actuation element 45. At this point, simply by ceasing the manual thrust on the external part 48 of the actuation element 45, the latter will automatically go into its clamping position (FIG. 11), due to the action of the first helical spring 50, that is with its internal part 47 in cooperation with the terminal tooth 40.

The rapid release of each dispensing unit 25 from the corresponding support member 24 takes place in an equally simple manner that is easy to perform. In fact, with the machine 10 stopped, it is sufficient to press the actuation element 45 inwards into its operating position (FIG. 12) and remove the entire dispensing unit 25 outwards, extracting its lower structure 41 from the through cavity 36 of the support member 24.

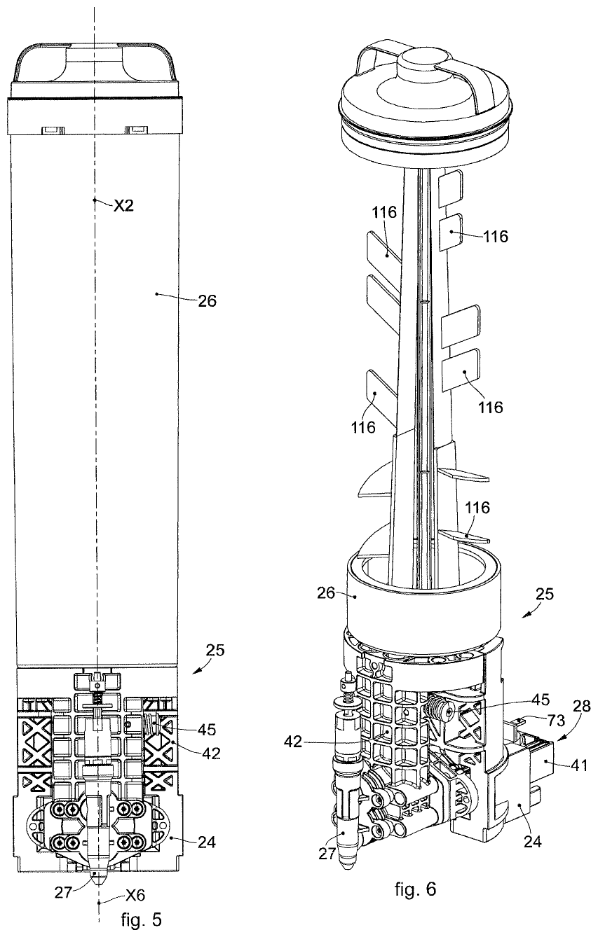

According to a variant, not shown in the drawings, but easily understandable by a person of skill in the art, the actuation element 45 can be disposed so that it protrudes from the left side of the intermediate structure 42, that is from the opposite side to that shown in the drawings, in particular with reference to FIG. 5.

It should be noted that, in consideration of the not excessive weight of each dispensing unit 25, which with the tank 26 full of fluid product is, for example, in the order of a few kilograms, and in consideration of the conformation (sizes, shape) of the intermediate structure 42 and the dispensing nozzle 27, the rapid attachment and release of each dispensing unit 25 to/from the support member 24 can be carried out using a single hand of an operator, or the user of the machine 10 itself, in particular the same hand with which the person holds the dispensing unit 25. In fact, thanks to the advantageous conformation of the lower structure, the operator, or the user himself, can press the actuation element 45 with just one digit, for example the thumb, of the same hand with which he/she is supporting the dispensing unit 25. For this purpose, the actuation element 45 is disposed adjacent to the intermediate structure 42, protruding with respect to it in a position such that it can be driven with just one finger of the hand with which the operator is grasping the intermediate structure 42 to support the dispensing unit 25. This is advantageous because the attachment and detachment operation is easy to perform, if necessary leaving the operator, or the user, a free hand for other needs.

### Actuation Unit

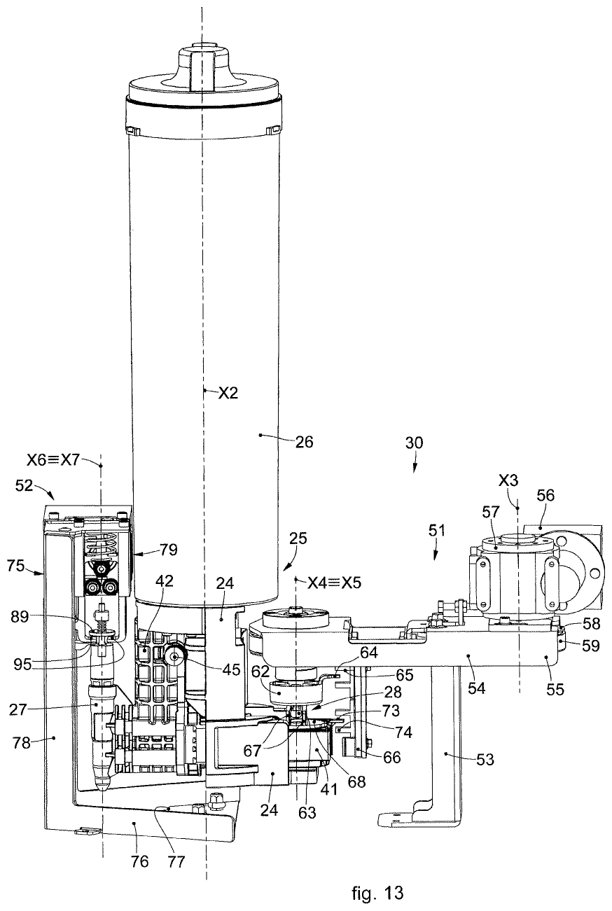

Another of the inventive aspects of the present invention is represented by the actuation unit 30 (FIGS. 13 to 18), which is configured to selectively cooperate with one dispensing unit 25 at a time, when the latter, by rotating the platform 17 around the central vertical axis X1, is taken by the first electric motor 23 (FIG. 3) into correspondence with the dispensing zone 15.

In particular, the actuation unit 30 consists of an internal part 51 (FIG. 2), attached on the upper horizontal plate 14, inside the through central cavity 18, and an external part 52, attached on the upper horizontal plate 14, but outside the rotatable platform 17, so as not to interfere with the latter.

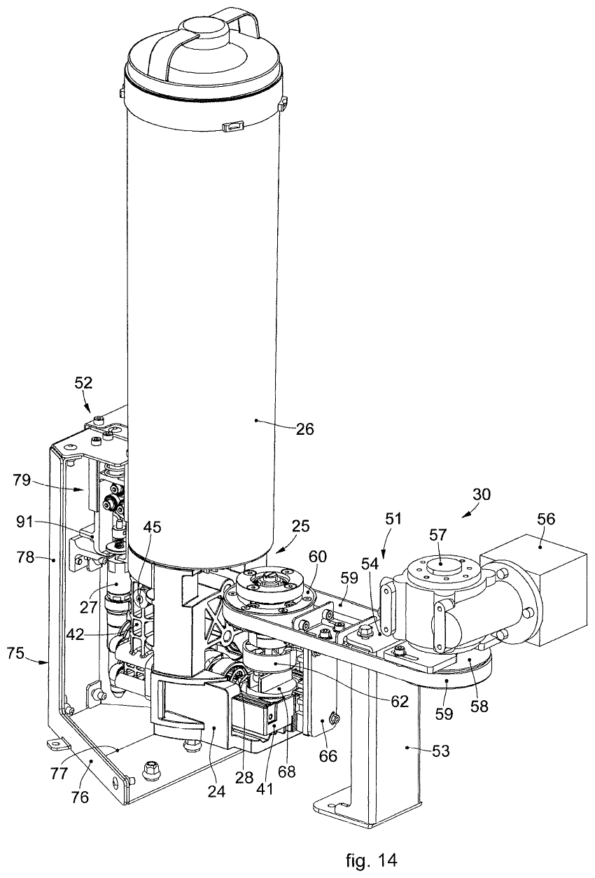

The internal part 51 is configured to selectively activate the volumetric pump 28 (FIGS. 13 and 14), while the external part 52 is configured to selectively activate the dispensing nozzle 27 of the dispensing unit 25 which is temporarily located in the dispensing zone 15.

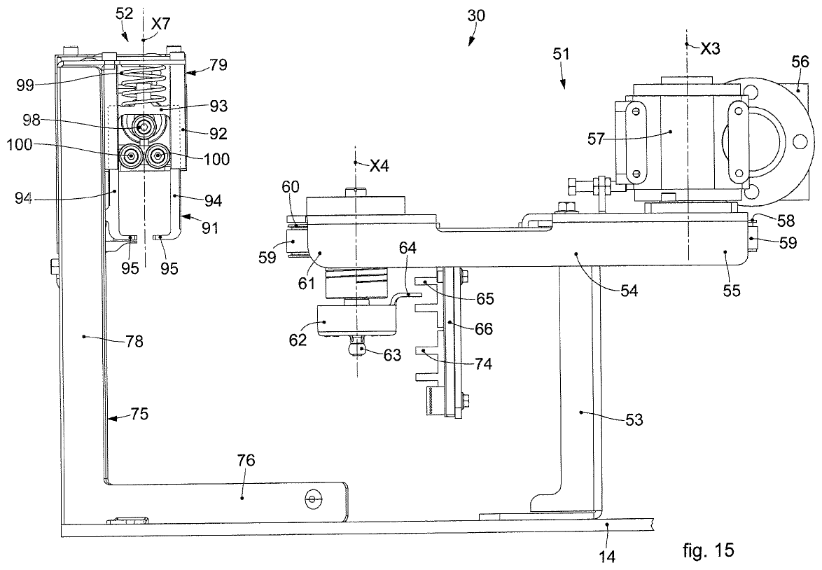

The internal part 51 comprises a first vertical upright 53, which is attached on the upper horizontal plate 14 (FIG. 15) and supports a first horizontal support 54, which has a first end 55 on which a second electric motor 56 is mounted, with the relative speed reducer 57. Onto the lower part of the shaft of the speed reducer 57 (FIG. 14) is keyed a first toothed pulley 58, which is configured to transmit the rotary motion, through a first toothed belt 59, to a second toothed pulley 60, which is pivoted on a second end 61 of the first horizontal support 54. The vertical axes of rotation X3 and X4 of the two toothed pulleys 58 and 60 intersect the first radial axis Y1.

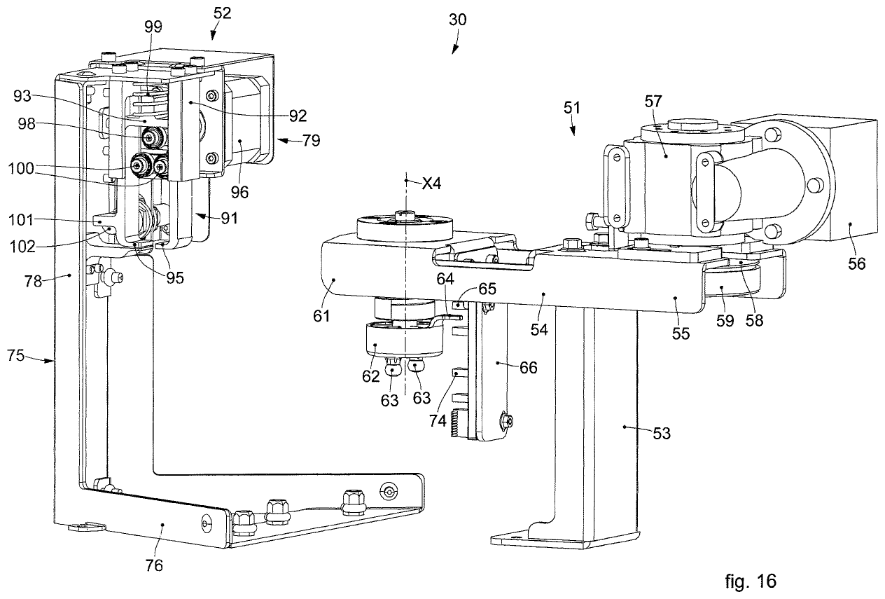

In the lower part of the second toothed pulley 60 a mandrel 62 is attached, having, on its lower surface, two small wheels 63 (FIG. 16) disposed on diametrically opposite sides and symmetrical with respect to the vertical axis of rotation X4 of the same second toothed pulley 60.

The mandrel 62, in its upper part, is provided with a radial fin 64, protruding towards the outside and configured to cooperate with a first position sensor 65, supported by a vertical plate 66 attached to the lower part of the first horizontal support 54. In an inactive position the mandrel 62 has its small wheels 63 disposed perpendicular to the first radial axis Y1.

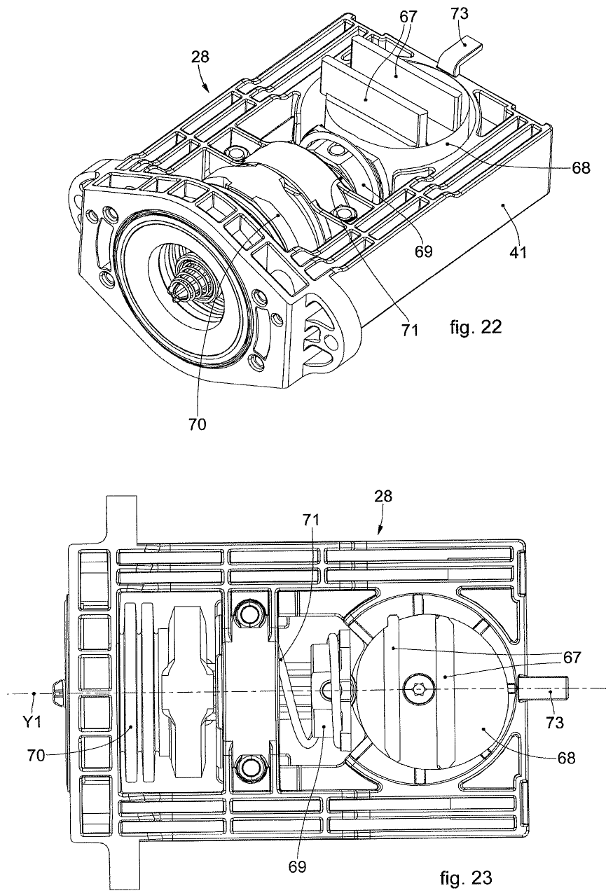

The two small wheels 63 of the mandrel 62 are configured to cooperate with the internal part of two vertical fins 67 (FIGS. 13, 21, 22 and 23) of an eccentric disk 68, disposed in the lower structure 41 of the dispensing unit 25. In particular, the two vertical fins 67 are parallel to each other and disposed equidistant from a vertical axis of rotation X5 of the eccentric disk 68. Furthermore, the two vertical fins 67, in their inactive angular position, are perpendicular to the first radial axis Y1 (FIGS. 21 and 23), to intercept the small wheels 63 of the mandrel 62, which are disposed in the cavity defined between the same two vertical fins 67, without interfering with the latter, when the dispensing unit 25 goes into the dispensing position, that is in correspondence with the actuation unit 30.

In its turn the eccentric disk 68 cooperates with a piston 69, which is axially mobile along the first radial axis Y1 and is configured to drive a bellows 70 of the volumetric pump 28 in a known manner. A second helical spring 71 is disposed around the piston 69 to keep the latter constantly against the eccentric disk 68. Furthermore, the bellows 70 is in communication with the corresponding tank 26 by means of a suction pipe 72, partly visible in FIG. 21.

Furthermore, on the innermost part of the lower structure 41 there is a horizontal fin 73, protruding towards the inside of the machine 10, to cooperate with a second position sensor 74 (FIGS. 13, 15 and 16), mounted on the vertical plate 66 below the first position sensor 65.

The external part 52 of the actuation unit 30 (FIGS. 13 to 18) comprises a support bracket 75 having both a horizontal part 76, attached on the upper horizontal plate 14 (FIG. 15) and provided with a through cavity 77 (FIG. 14) disposed in correspondence with the through cavity 16 (FIG. 1), and also a vertical part 78 (FIGS. 13 to 18), at the upper end of which a lifting mechanism 79 is mounted, configured to selectively cooperate with the dispensing nozzle 27 of the dispensing unit 25, when the latter is in its dispensing position, in correspondence with the actuation unit 30.

In particular, in the embodiment shown here by way of example, each dispensing nozzle 27 (FIGS. 19 and 20) comprises an external structure 80, substantially tubular and having a vertical axis X6. Inside the external structure 80 there is an axial cavity 81, in which the dispensing pipe 43 arrives and which in its lower part ends in a dispensing orifice 82, from which the fluid contained in the corresponding tank 26 can selectively exit. An axial stem 83 is disposed in the axial cavity 81 and comprises both a lower end 84, flared and configured to cooperate with the dispensing orifice 82, and an intermediate plugging 85 configured to cooperate with the lower end of a tube 86 inserted precisely in the axial cavity 81 and in turn having its own axial cavity 87, from which the recirculation pipe 44 departs, which ends inside the corresponding tank 26. Furthermore, each axial stem 83 has an upper end 88 which protrudes from the external structure 80 and is integral with a horizontal disk 89.

A third helical spring 90, disposed inside the upper part of the external structure 80, constantly thrusts the axial stem 83 downwards, so that the latter, in an inactive condition, shown in FIG. 19, with its lower end 84 keeps the dispensing orifice 82 closed. Furthermore, in this inactive condition, the intermediate plugging 85 is detached from the lower end of the tube 86, so that the dispensing pipe 43 is in fluidic communication with the recirculation pipe 44.

The lifting mechanism 79 comprises a slider 91 mobile vertically along a vertical axis X7 inside a box-like guide element 92, attached to the upper end of the vertical part 78 of the support bracket 75. In an operating condition of the actuation unit 30, the vertical axis X6 of the dispensing nozzle 27 coincides with the vertical axis X7 of the slider 91 (FIG. 13).

The slider 91 comprises a horizontal crosspiece 93 (FIGS. 15 to 18) and two vertical arms 94 which each end with a lower tooth 95. The two teeth 95 lie on the same horizontal plane and have their tips distanced from each other and equidistant from the vertical axis X7, so as to allow the insertion between them of the upper end 88 of the axial stem 83. Furthermore, in an inactive condition of the lifting mechanism 79, the vertical position of the two lower teeth 95, with respect to the upper horizontal plate 14 (FIG. 15) and to the dispensing nozzle 27 (FIG. 13), is such that the horizontal disk 89 of the latter will be positioned slightly above the two lower teeth 95.

The lifting mechanism 79 also comprises a third electric motor 96 (FIGS. 16 to 18) having a drive shaft 97 on which a central small wheel 98 is eccentrically attached, at a distance C (FIG. 18), rotatably disposed below the horizontal crosspiece 93 of the slider 91. A fourth helical spring 99 (FIGS. 16 to 18), disposed inside the box-like guide element 92, constantly thrusts the slider 91 downwards. Two lateral small wheels 100 are rotatably supported by the box-like guide element 92 in order to guide the slider 91 from the inside.

The slider 91 is also provided with a lateral fin 101 configured to cooperate with a third position sensor 102 mounted on the support bracket 75.

### Mixing Unit

Another of the inventive aspects of the present invention is represented by the mixing unit 31 (FIGS. 2, 24 and 25), which is configured to cooperate selectively with one dispensing unit 25 at a time, when the latter, due to the rotation of the platform 17 around the central vertical axis X1, is taken by the first electric motor 23 (FIG. 3) into correspondence with a mixing zone 103 (FIG. 2), disposed along the second radial axis Y2.

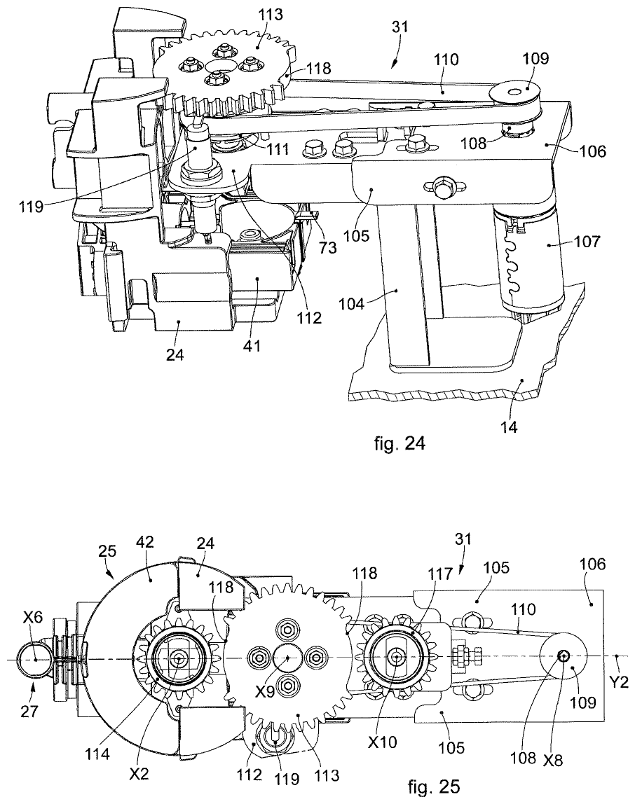

The mixing unit 31 comprises a second vertical upright 104, which is attached on the upper horizontal plate 14 (FIG. 24) and supports a second horizontal support 105, which has a first end 106 on which a fourth electric motor 107 is mounted, coaxial to a vertical axis X8 (FIG. 25) and having its own drive shaft 108 onto which a third toothed pulley 109 is keyed, which is configured to transmit the rotary motion, through a second toothed belt 110, to a fourth toothed pulley 111, which is pivoted on a second end 112 of the second horizontal support 105. The vertical axes of rotation X8 and X9 of the two toothed pulleys 109 and 111 intersect the second radial axis Y1.

Onto the upper part of the rotation shaft of the fourth toothed pulley 111 is keyed a second toothed pinion 113, which is configured to selectively engage with a first toothed wheel 114 (FIG. 7, 21, 25) mounted rotatably below each tank 26, coaxially to the vertical shaft X2 of the latter. The first toothed wheel 114 is keyed onto a first axial shaft 115 (FIG. 6) of the corresponding tank 26, provided with radial blades 116 configured to effect the mixing of the fluid product contained in the same tank 26, by means of the rotation of the axial shaft 115.

Furthermore, in the example given here, each of the four tanks 26 with connected double cylinder (FIG. 1) is also provided at the bottom part with a second toothed wheel 117 (FIG. 2), identical and coplanar to the first toothed wheel 114, but rotatable around its own vertical axis X10, onto which a second axial shaft is keyed, not shown in the drawings but identical to the first axial shaft 115 and also provided with radial blades.

So that the toothed wheels 114 and 117 (FIG. 25) do not interfere with the engagement teeth of the second toothed pinion 113, when each dispensing unit 25 moves into correspondence with, or passes through the mixing unit 31, the same second toothed pinion 113 has two circular sectors 118, diametrically opposite each other, which do not have engagement teeth. The angular amplitude of each circular sector 118 is such as to allow in any case the second toothed pinion 113, by rotating, to engage with its engagement teeth the engagement teeth of the first toothed wheel 114 and, when present, also those of the second toothed wheel 117.

Furthermore, a fourth position sensor 119 is mounted on the second end 112 of the second horizontal support 105 to detect the angular position of the second toothed pinion 113.

In an inactive position of the mixing unit 31, shown in FIGS. 2, 24 and 25, the two circular sectors 118 of the second toothed pinion 113 lie on the second radial axis Y2, so that the rotation of the platform 17 can take place without any interference with the same mixing unit 31. In one operating position of the mixing unit 31, the second toothed pinion 113 is rotated by driving the fourth electric motor 107, which sets in motion the third toothed pulley 109, the second toothed belt 110 and the fourth toothed pulley 111. In this operating position, not shown, the second toothed pinion 113, rotating, engages with the first toothed wheel 114 and possibly, if present, with the second toothed wheel 117 in order to rotate the respective axial shafts so as to obtain the mixing of the fluid product.

Finally, the machine 10 also comprises an electronic control unit 120, shown schematically in FIG. 1 and which can be of any known type, or which will be developed in the future, which is configured to suitably command the four electric motors 23, 56, 96 and 107, in response to the signals from at least the position sensors 65, 74, 102 and 119 and from a control console, not shown in the drawings.

The functioning of the machine 10 described heretofore, which substantially corresponds to the method for the automatic dispensing of fluid products according to the present invention, is as follows.

In an initial condition, shown in FIG. 1, the machine 10 is with the platform 17 stationary.

In this position it is possible to carry out an installation step and/or a possible removal step of any of the dispensing units 25 which is not temporarily in correspondence with the actuation unit 30, by a simple manual drive of the actuation element 45, as described above.

There then follows a step of dispensing the fluid product contained in a specific tank 26 of one of the dispensing units 25. The dispensing step comprises first of all an angular positioning sub-step, in which the selected dispensing unit 25 is taken into correspondence with the actuation unit 30 by means of the selective rotation of the platform 17 (FIG. 3) by the first electric motor 23.

In this position, in order to dispense a desired quantity of fluid product, the first electric motor 23, and consequently the platform 17, are kept stationary, and the third electric motor 96 is driven (FIGS. 16, 17 and 18), which performs a 180° rotation of its drive shaft 97; the latter, through the central small wheel 98, causes the slider 91 to lift, which, with its lower teeth 95, lifts the horizontal disk 89 (FIG. 13) and the axial stem 83 (FIG. 20) integral with it, so that the dispensing orifice 82 opens, which is in communication with the dispensing pipe 43, while, at the same time, the intermediate plugging 85 abuts on the lower part of the tube 86 and closes and isolates the recirculation pipe 44.

Furthermore, the second electric motor 56 is also selectively driven (FIG. 13), which drives the volumetric pump 28, by rotating the mandrel 62, which has its small wheels 63 engaging with the vertical fins 67 of the eccentric disk 68.

It should be noted that, in this position, instead of dispensing a desired quantity of fluid product, it is also possible to recirculate the latter, simply by driving only the second electric motor 56, keeping the third electric motor 96 stationary in its initial position. In fact, in this condition the dispensing orifice 82 remains closed and the drive of the volumetric pump 28 will cause a recirculation of the fluid product in the tank 26, through the circuit created by the suction pipe 72, the volumetric pump 28, the dispensing pipe 43, the axial cavities 81 and 87 of the dispensing nozzle 27 and the recirculation pipe 44 (FIGS. 19 and 21).

When it is desired to mix the fluid product contained in one of the tanks 26, a mixing step is carried out, taking the corresponding dispensing unit 25 into the mixing zone 103 (FIG. 3), by driving the first electric motor 23 (FIG. 3) which rotates the platform 17 until the first toothed wheel 114 (FIGS. 24 and 25) and possibly also the second toothed wheel 117, if present, go into correspondence with the second toothed pinion 113 of the mixing unit 31. The fourth electric motor 107 is then driven in order to rotate the axial shaft 115 (FIG. 6), which with its radial blades 117 mixes the fluid product, to prevent it from drying out.

From the above it is clear that all the steps of the operating cycle described above can be automatically managed by the electronic control unit 120 and that any possible removal and/or replacement of each of the dispensing units 25 can be carried out easily and with great simplicity even by a non-specialized person.

It is clear that modifications and/or additions of parts may be made to the machine 10 and the corresponding method as described heretofore, without departing from the field of the present invention.

It is also clear that, although the present invention has been described with reference to a specific examples of an embodiment, a person of skill in the art shall certainly be able to achieve many other equivalent forms of machines and methods to automatically dispense fluid products, in particular liquid dyes, having the characteristics as set forth in the claims and hence all coming within the field of protection defined thereby.

1. A machine to automatically dispense at least one fluid product, in particular a liquid dye, comprising support means configured to support at least one dispensing unit including a tank, in which said fluid product to be dispensed is contained, a dispensing nozzle and pumping means configured to selectively convey a desired quantity of said fluid product from said tank to said dispensing nozzle and from the latter to an external containing mean, wherein each dispensing unit is mounted individually removable on a platform selectively rotatable with respect to a fixed structure, around its own central axis, and wherein said support means are mounted on said platform so as to rotate together therewith, wherein the machine, also, comprises rapid attachment means configured to allow the positioning of said at least one dispensing unit on said support means and the removal of said at least one dispensing unit from said support means.

2. The machine as in claim 1, wherein said rapid attachment means comprise fixed attachment means mounted on said support means, and an attachment member, mounted on said dispensing unit, and mobile between a clamping position in which said dispensing unit is clamped in position in the respective support means, and a release position in which said dispensing unit is free to be removed from the respective support means.

3. The machine as in claim 2, wherein said fixed attachment means comprise an attachment element integral with said support means and having one end protruding horizontally towards the outside of the machine and provided with a through hole which defines a terminal tooth, and wherein said attachment member comprises an actuation element which can be driven manually in order to take said attachment member from said clamping position to said release position.

4. The machine as in claim 3, wherein said actuation element is configured to selectively cooperate with said terminal tooth, it is disposed axially mobile inside a corresponding cylindrical cavity made in a structural part of said dispensing unit in order to alternatively take said attachment member into said clamping position or into said release position, and wherein said actuation element is provided with a recess, having a shape mating with at least part of the profile of said terminal tooth, being configured to align with the latter when said attachment member is in the release position in order to allow the positioning or the removal of said dispensing unit from said support means, and alternatively to misalign from said terminal tooth when said attachment member is in the clamping position.

5. The machine as in claim 4, wherein the machine comprises an elastic conditioning mean disposed around at least a portion of said actuation element, in order to constantly thrust said actuation element towards said clamping position.

6. The machine as in claim 4, wherein the weight of said dispensing unit and the conformation of said structural part, are such as to allow an operator to grasp and handle said dispensing unit with a single hand, and wherein said actuation element is disposed adjacent to said structural part, protruding with respect to the latter in a position such as to be able to be driven with only one finger of the said hand with which the operator is grasping said structural part in order to support said dispensing unit.

7. The machine as in claim 1, wherein said support means comprise a rigid structure provided with a substantially horizontal through cavity and wherein said pumping means are contained in a lower structure of said dispensing unit, having substantially a cross section substantially mating with that of said through cavity, so that the latter can accurately house said lower structure of said dispensing unit when the latter is mounted on said support means.

8. The machine as in claim 1, wherein the relative disposition of the dispensing units and the support members is such that an installation movement and a removal movement of each dispensing unit with respect to its own respective support member occurs exclusively in a radial directrix, without any component of axial movement, that is parallel to said vertical central axis.

9. The machine as in claim 1, wherein the machine, also, comprises a single actuation unit disposed radially with respect to said central axis in a dispensing zone of said fixed structure and configured to selectively and autonomously actuate both said dispensing nozzle, and said pumping means of the dispensing unit which is temporarily located in said dispensing zone, by rotating said platform.

10. The machine as in claim 9, wherein said platform has a substantially annular shape and defines a central through cavity, wherein said plurality of dispensing units are disposed in a circle on said platform and wherein said actuation unit comprises both an internal part, mounted on said fixed structure in said through central cavity and configured to selectively activate said pumping means, and an external part mounted on said fixed structure but outside said platform and configured to selectively activate said dispensing nozzle of said selected dispensing unit.

11. The machine as in claim 10, wherein said internal part comprises at least one mandrel configured to be selectively taken into rotation, around its own axis of rotation and provided with first engagement means configured to be selectively coupled with corresponding second engagement means of said pumping means of said selected dispensing unit.

12. The machine as in claim 11, wherein said first engagement means comprise two small wheels disposed in the lower part of said mandrel, on diametrically opposite sides and symmetrical with respect to said axis of rotation of the latter, wherein said second engagement means comprise two fins, parallel with respect to each other and disposed in the upper part of a disk rotatable inside a lower structure of said dispensing unit, in which said pumping means are also housed, and wherein said two fins define with respect to each other a cavity configured to house said two small wheels when said selected dispensing unit is located in correspondence with said actuation unit.

13. The machine as in claim 12, wherein said disc is mounted eccentric with respect to its axis of rotation and cooperates with an actuation piston of said pumping means, by means of a conditioning member which constantly bolds said actuation piston against the peripheral surface of said disk.

14. The machine as in claim 10, wherein said dispensing nozzle comprises both an external structure which defines an axial cavity having a dispensing orifice in its lower terminal part, and an axial stem disposed inside said axial cavity and which is normally in an inactive condition in which the axial stem keeps said dispensing orifice closed, and wherein said external part of said actuation unit comprises actuation means configured to cooperate with said axial stem of said dispensing nozzle, when said selected dispensing unit is located in correspondence with said actuation unit, in order to selectively take the axial stem from said inactive condition to an operating condition, in which said axial stem is raised and keeps said dispensing orifice open, and vice versa.

15. The machine as in claim 14, wherein said actuation means comprise a slider mounted sliding along its own vertical axis and having two vertical arms provided at the bottom part with two teeth which lie on the same horizontal plane and have their tips distanced from each other and equidistant from said vertical axis of said slider, so as to allow the insertion between them of an upper end of said axial stem to cooperate with a horizontal element integral with the latter.

16. A method to automatically dispense at least one fluid product, in particular a liquid dye, by means of a machine having support means configured to support at least one dispensing unit comprising a tank, in which said fluid product to be dispensed is contained, a dispensing nozzle and pumping means configured to selectively convey a desired quantity of said fluid product from said tank to said dispensing nozzle and from the latter to an external containing mean, wherein each dispensing unit is mounted individually removable on a platform selectively rotatable with respect to a fixed structure, around its own central axis, and wherein said support means are mounted on said platform so as to rotate together therewith, said method installing and possibly subsequently removing said at least one dispensing unit by means of rapid attachment means configured to allow the positioning of said at least one dispensing unit on said support means and the removal of said at least one dispensing unit from said support means.

17. The method as in claim 16, wherein installing said at least one dispensing unit comprises graying a structural part of said dispensing unit, possibly also with only one hand of an operator, so that said dispensing unit can be positioned in correspondence with said support means, and, simultaneously with or prior to installing the dispensing unit, driving an actuation element, which is part of said rapid attachment means, possibly also with only one finger of said hand, to cooperate with fixed attachment means, which are also part of said rapid attachment means and which are mounted on said support means.

18. The method as in claim 16, further comprising dispensing said fluid product by means of a single actuation unit configured to selectively and autonomously actuate both said dispensing nozzle, and said pumping means of the selected dispensing unit that is temporarily located in a dispensing zone, by rotating said platform.

19. The machine as in claim 5, wherein the weight of said dispensing unit and the conformation of said structural part, are such as to allow an operator to grasp and handle said dispensing unit with a single hand, and wherein said actuation element is disposed adjacent to said structural part, protruding with respect to the latter in a position such as to be able to be driven with only one finger of the said hand with which the operator is grasping said structural part in order to support said dispensing unit.

20. The machine as in claim 11, wherein said dispensing nozzle comprises both an external structure which defines an axial cavity having a dispensing orifice in its lower terminal part, and an axial stem disposed inside said axial cavity and which is normally in an inactive condition in which the axial stem keeps said dispensing orifice closed, and wherein said external. part of said actuation unit comprises actuation means configured to cooperate with said axial stem of said dispensing nozzle, when said selected dispensing unit is located in correspondence with said actuation unit, in order to selectively take the axial stem from said inactive condition to an operating condition, in which said axial stem is raised and keeps said dispensing orifice open, and vice versa.
